(19) United States
(12) Patent Application Publication
(10) Pub. No.: US 2017/0138519 A1
(43) Pub. Date: May 18, 2017

(54) MULTI-PLATE QUICK DISCONNECT FITTING

(71) Applicant: Stephen B. MAGUIRE, West Chester, PA (US)

(72) Inventor: Stephen B. MAGUIRE, West Chester, PA (US)

(21) Appl. No.: 15/420,762

(22) Filed: Jan. 31, 2017

Related U.S. Application Data
(63) Continuation-in-part of application No. 14/587,921, filed on Dec. 31, 2014, now Pat. No. 9,599,265.
Application No. 14/587,921 is a continuation-in-part of application No. 13/913,375, filed on Jun. 7, 2013, now Pat. No. 9,188,118.
Application No. 13/913,375 is a continuation-in-part of application No. 14/617,035, filed on Feb. 9, 2015.
Application No. 14/617,035 is a continuation-in-part of application No. 14/700,911, filed on Apr. 30, 2015.
Application No. 14/700,911 is a continuation-in-part of application No. 14/886,442, filed on Oct. 19, 2015.
Application No. 14/886,442 is a continuation-in-part of application No. 15/298,802, filed on Oct. 20, 2016.
Application No. 15/298,802 is a continuation of application No. 14/168,731, filed on Jan. 30, 2014, now abandoned.
(60) Provisional application No. 61/660,326, filed on Jun. 15, 2012.

(51) Int. Cl. F16L 37/08; F04B 53/16; F04B 23/02; F04B 43/067

(52) U.S. Cl. CPC F16L 37/08; F04B 43/067; F04B 53/16; F04B 23/021

(57) ABSTRACT

A fitting allowing a quick connection and disconnection of liquid color conduits includes a quick disconnect plate assembly having three plates layered on top of each other, the top plate including guides sized to receive projections extending from structure to which the fitting is to be connected, with the middle plate including stops engaging the same projections upon rotation of the structure.

### CROSS REFERENCE TO RELATED PATENT APPLICATIONS

This patent application is a continuation-in-part of U.S. patent application Ser. No. 14/587,921 filed 31 Dec. 2014 in the name of Stephen B. Maguire and published as U.S. 2015/0108748A1, the priority of which is claimed under 35 USC 120.

The '921 application claims the benefit of the priority under 35 USC 120 of U.S. patent application Ser. No. 13/913,375 filed 7 Jun. 2013 in the name of Stephen B. Maguire and entitled “Injection Molded Pump for Liquid Color with Quick Release,” which is now U.S. Pat. No. 9,188,118 issued 17 Nov. 2015.

The '118 patent claimed the benefit of the priority of U.S. provisional application 61/660,326 filed 15 Jun. 2012 in the name of Stephen B. Maguire and entitled “Molded Diaphragm Pump.”

This application claims the benefit of the priority under 35 USC 119 and 120 of the '326 application through the '118 patent and the '921 application.

This application also claims the benefit of the priority of the '118 patent under 35 USC 120.

This patent application also claims the benefit of the priority under 35 USC 120 and is a continuation-in-part of U.S. patent application Ser. No. 14/617,035 filed 9 Feb. 2015 in the name of Stephen B. Maguire and entitled “Quarter Turn Adaptor Connective Outlet Fitting for Liquid Color Dispensing.”

This patent application further claims the benefit of the priority under 35 USC 120 and is a continuation-in-part of U.S. patent application Ser. No. 14/700,911 filed 30 Apr. 2015 in the name of Stephen B. Maguire and entitled “Pulsed Pneumatic Control of Liquid Color Pumps.”

This patent application further claims the benefit of the priority under 35 USC 120 and is a continuation-in-part of U.S. patent application Ser. No. 14/886,442 filed 19 Oct. 2015 in the name of Stephen B. Maguire and entitled “Molded Diaphragm Liquid Color Pump.”

This patent application further claims the benefit of the priority under 35 USC 120 and is a continuation-in-part of U.S. patent application Ser. No. 15/298,802 filed 20 Oct. 2016 in the name of Stephen B. Maguire and entitled “Pump Actuator and Method for Pump Operation”, which in turn was a 35 USC 120 continuation of U.S. patent application Ser. No. 14/168,731 filed 30 Jan. 2014 in the name of Stephen B. Maguire and entitled “Pump Actuator and Method of Pump Operation”, which is now abandoned and which was a 35 USC 120 continuation-in-part of U.S. patent application Ser. No. 13/913,375, now U.S. Pat. No. 9,188,118 as identified above.

### STATEMENT REGARDING FEDERAL FUNDING RESPECTING THIS APPLICATION

Not applicable.

### INCORPORATION BY REFERENCE

This patent application incorporates by reference the disclosure of U.S. Pat. No. 9,188,118 issued 17 Nov. 2015.

This application further incorporates by reference the disclosure of U.S. patent publication 2014/0147288 A1, published 29 May 2014.

This patent application still further incorporates by reference the disclosure of U.S. patent publication 2015/0108748 A1, published 23 Apr. 2015.

This patent application still further incorporates by reference the disclosure of U.S. patent publication 2015/0158638 A1, published 11 Jun. 2015.

This patent application still further incorporates by reference the disclosure of U.S. patent publication 2015/0233365 A1, published 20 Aug. 2015.

This patent application still further incorporates by reference the disclosure of U.S. patent publication 2015/0040661 A1, published 11 Feb. 2015.

This patent application further incorporates by reference the disclosures of U.S. Pat. Nos. 7,416,096; 7,980,834; and 8,800,821.

### BACKGROUND OF THE INVENTION

This invention pertains principally but not exclusively to the use of liquid color in plastic molding and extrusion. The patent application even more specifically pertains to a multiple plate quick disconnect sandwich assembly preferably, but not necessarily, utilized with a liquid color pump installed on and forming a part of a liquid color container.

Pumps for liquid color are known, with one such pump being disclosed in U.S. Pat. No. 7,416,096, with another being disclosed in U.S. Pat. No. 7,980,834, and yet another being disclosed in U.S. Pat. No. 8,800,821.

'096 discloses a container for liquid color material having a diaphragm liquid color pump located in the container for pumping liquid color from the container. The diaphragm liquid color pump is located in the container at the container bottom, where the pump can collect liquid color as the container empties. The pump is driven by a pneumatic piston-cylinder combination located outside the container, with a shaft extending downwardly from the pneumatic piston-cylinder combination to the diaphragm pump, to reciprocate the diaphragm back and forth to effectuate pumping action.

The '096 apparatus is relatively low in cost. The apparatus includes a liquid-tight fitting allowing liquid color output from the pump to be supplied directly to a plastics material processing machine, namely a molding press or an extruder, for the liquid color to impart color directly to plastic parts as they are manufactured.

The '834 apparatus provides pressure boosting, permitting liquid color to be injected into an extruder screw or a molding machine screw barrel close to the position at which the finished plastic parts are molded or extruded.

'821 discloses a disposable low-cost pump in a container for liquid color, where the pump is fabricated from a plurality of PVC tubular members connected in a way to provide a pumping chamber. A piston is displaceable into the pumping chamber. A spring biases the piston outwardly from the chamber, in opposition to force applied by an air cylinder.

While these devices have merit and have proved commercially successful, there is a continuing need for lower cost, higher reliability quick connection apparatus to connect conduits to pumps and the like, to provide liquid color from liquid color containers to injection and compression molding machines and to extruders, to color plastic parts in the course of manufacture thereof.

### DESCRIPTION OF THE INVENTION

In one of its aspects, this invention provides a quick disconnect multiple plate sandwich assembly that is particularly adapted for connecting two conduits together with at least one of the conduits being within or part of a structure to which the sandwich assembly is secured, preferably by bolts, for flow of liquid color therebetween and for facilitating rapid connection and disconnection of liquid color input fittings and liquid color out to and/or from a liquid color pump or other device. However, the invention is not limited to liquid color applications.

The quick disconnect sandwich assembly fitting preferably includes a first plate, a second plate, and a third plate. The three plates when assembled are preferably superimposed on top of each other to form a sandwich structure, with the second plate preferably positioned between the first plate and the third plate.

Each of the plates preferably includes at least one circular arcuate interior opening, with all of the associated, corresponding openings on the respective plates preferably formed on a common center. Desirably, each of the plates has two openings, one being larger than the other. The larger openings in each of the plates are referred to herein as being “associated” with corresponding larger openings that are present in each of the other plates. Desirably, each of the plates also includes a smaller opening. The smaller openings are also referred to herein as being “associated” with corresponding smaller openings that are desirably present in each of the other plates.

The diameter of an arcuate interior larger opening of the first plate, sometimes referred to herein as the “base” plate, is preferably the smallest of the three associated larger arcuate interior openings. The diameter of the larger arcuate interior opening of the second plate, sometimes referred to herein as the “spacer” plate, is the largest of the three associated larger arcuate interior openings. The diameter of the arcuate interior larger opening of the third plate, sometimes referred to herein as the “retainer” plate, is larger than that of the associated larger opening in the first plate and smaller than that of the associated large opening in the second plate.

The retaining aspect of the invention is preferably provided by interplay of the structures of the second and third plates and a conduit or conduit housing that is remotely connected to the second and third plates. The second plate preferably includes a pair of inwardly facing stops positioned oppositely one another on the larger arcuate interior opening. The third plate preferably includes a pair of guides formed in the larger arcuate interior opening, with each guide having a leading end and a trailing end. Receptors preferably located at the leading end of each guide are axially displaced from a first surface of the third plate, opposite the surface of the third plate that contacts the second plate. The receptors each preferably have upper and lower surfaces, with the lower surfaces of the receptors at the receptor first extremities being displaced in the axial direction from the first surface of the third plate. The upper and lower surfaces of the receptors preferably taper smoothly from the extremities of the receptors to a junction with the guide.

The first, second, and third plates desirably each include a smaller second arcuate opening. As with the larger first arcuate opening, the associated smaller second arcuate opening of the second plate preferably includes a pair of inwardly facing stops positioned oppositely one from another on the smaller arcuate interior opening, and the third plate preferably includes a pair of guides formed in an associated smaller arcuate interior opening, with each guide having a leading end and a trailing end. Similarly, receptors located at the leading end of each guide are preferably axially displaced from a first surface of the third plate opposite the surface contacting the second plate.

Additional objects, other advantages, and further novel features of the invention will become apparent from the appended claims and as the ensuing detailed discussion and description of the preferred embodiments of the present invention proceeds in conjunction with the accompanying drawings.

### BRIEF DESCRIPTION OF THE DRAWINGS

FIG. 1 is a top view of a retainer plate, a spacer plate, and a base plate manifesting aspects of the invention.

FIG. 2 is an exploded isometric schematic view of the multiple plate quick disconnect sandwich showing, from top to bottom, a retainer plate, a spacer plate, and a base plate, as shown in FIG. 1.

FIG. 3 is an isometric view of the multiple plate quick disconnect sandwich, illustrated in FIGS. 1 and 2 in assembled form.

FIG. 4 is a sectional view of the assembled multiple plate quick disconnect sandwich taken at lines and arrows B-B in FIG. 3.

### DESCRIPTION OF THE INVENTION

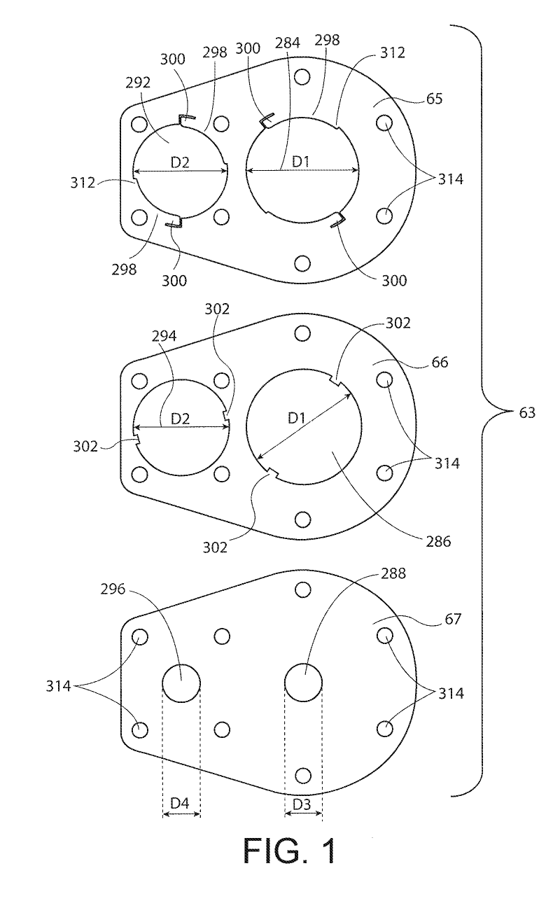

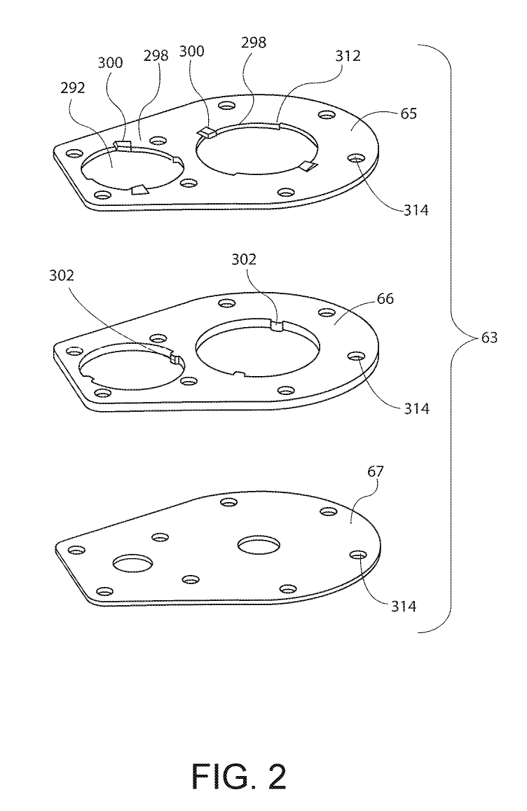

With reference to FIGS. 1 through 4, a multiple plate quick disconnect sandwich 63 includes a retainer plate 65, a spacer plate 66, and a base plate 67. Each of plates 65, 66, and 67 desirably include generally annular openings preferably corresponding to generally cylindrical connections of a pump inlet assembly and a pump outlet assembly or to conduits that are to be connected together and/or to pumps, to process machines, and the like. As depicted in the figures, the retainer plate 65 includes a larger arcuate passageway 284 and a smaller arcuate passageway 292; the spacer plate 66 includes a larger arcuate passageway 286 and a smaller arcuate passageway 294; and the base plate 67 includes a larger arcuate passageway 288 and a smaller arcuate passageway 296.

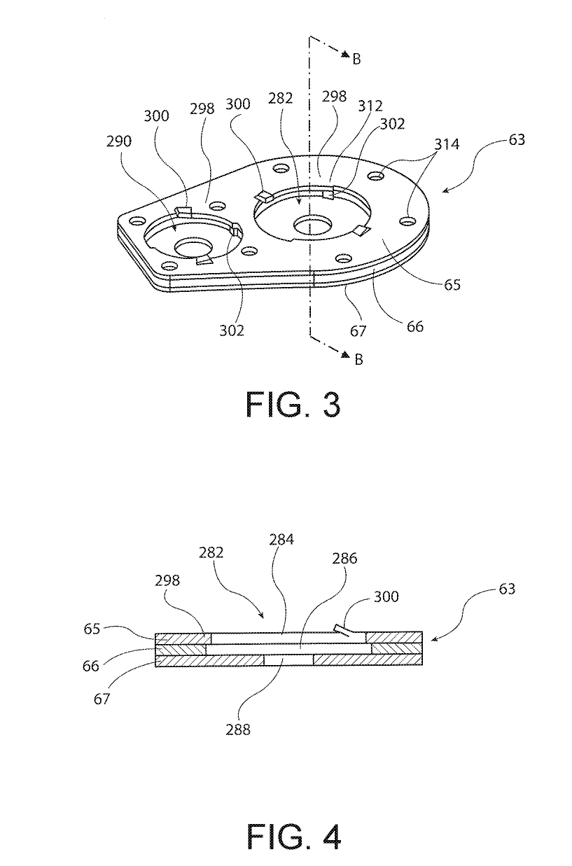

As shown in FIGS. 3 and 4, the respective plates are desirably placed on one another in facing disposition to create the quick disconnect sandwich 63. In this configuration, the respective associated larger and associated smaller passageways in each plate form what may be either an inlet or an outlet arcuate passageway 282 and what may be either an inlet or outlet arcuate passageway 290. The arcuate larger passageways 284, 286 of retainer plate 65 and spacer plate 66 are preferably formed on the same radius, such that they have the same diameter D1 and their respective smaller arcuate passageways 292, 294 have the same diameter D2.

Larger arcuate passageway 288 and smaller arcuate passageway 296 of base plate 67 are each preferably formed with smaller radii than that of associated larger arcuate passageways 284, 286 of the retainer and spacer plates 65, 66 and and with smaller radai than associated smaller outlet passageways 292, 294, of the retainer and spacer plates 65, 66, have diameters D3 and D4 respectively as illustrated in FIG. 1.

Diameters D1, D2, D3, and D4 are preferably determined by the dimensions of the inlets and outlets being connected. Diameter D1 is preferably substantially equivalent to the cross-sectional width/diameter of an associated assembly from the outer edge of one lug to the outer edge of an opposing lug. Similarly, diameter D2 is preferably substantially equivalent to the cross-sectional width/diameter of an associated assembly from the outer edge of one lug to the outer edge of an opposing lug. Diameter D3 and diameter D4 are chosen according to the conduit inlets and outlets being connected using the quick disconnect sandwich 63.

Retainer plate 65 preferably includes pairs of arcuate retaining guides 298, 298A with the guides extending slightly into retainer plate arcuate passageway 284 and the retainer plate arcuate passageway 292 on opposite sides thereof to form regions of reduced diameter in arcuate passageway 282 and in arcuate passageway 290, as illustrated in FIG. 1. Retaining guides 298, 298A preferably have an arc length of 80°, but it is understood that in alternative embodiments, the arc length of retaining guides 298, 298A may range from about 30° to about 150°.

Each retaining guide 298, 298A preferably extends from an associated sloped leading tab 300 to a trailing edge 312, with tab 300 and edge 312 defining the angular extremities of arcuate retaining guides 298, 298A. Each sloped leading tab 300 is preferably angled upwardly, away from spacer plate 66, about ten degrees with respect to the planar surface of retainer plate 65, which is opposite from the surface of plate 65 that facingly contacts plate 66.

Spacer plate 66 includes preferably generally rectangular stops 302 extending from the inner periphery of the arcuate passageways 286, 294 of spacer plate 66. As shown in FIG. 3, when plates 65, 66, 67 are placed on top of each other to form the quick disconnect sandwich 63, stops 302 are preferably both axially and angularly aligned with trailing edges 312 of retainer plate 65.

Each plate 65, 66, 67 of quick disconnect sandwich 63 includes openings 314 that align with the with openings in a structure or container or mechanism, to allow for mounting quick disconnect sandwich 63 to a structure or container or mechanism or a conduit for which rapid connection/disconnection of another structure or container or mechanism or conduit is desired. Nut and bolt combinations are preferably used for such mounts.

As respecting the operation of the invention, after quick disconnect sandwich 63 is assembled as shown in FIGS. 3 and 4, and is attached to a structure or container or mechanism or conduit, the structure to be quickly connected/disconnected may be centered over the arcuate passageway 290 of quick disconnect plate assembly 63 in a position such that a lower portions (of a structure to be connected), extends through arcuate passageway 296 of the quick disconnect base plate 67 and appropriately sized and positioned lugs are adjacent the sloped leadings tabs 300 of the retaining guides 298, while a lower planar surface of the lugs rests on the upper surface of the quick disconnect retainer plate 65. As the apparatus to be connected is rotated, the lug portions of the apparatus slide under sloped leading tabs 300 and then continue to moveably slide under the remainder of retaining guide 298 along the surface of the quick disconnect base plate until the lugs abut stops 302 on the quick disconnect spacer plate 66. Due to the angled configuration of the sloped leading tabs 300, the structure to be connected is gradually pressed against the outwardly facing surface of the quick disconnect base plate 67 as the structure to be connected is rotated into place. The overhang formed by the retaining guides 298 prevents displacement of the lugs of the structure to be connected in the vertical direction.

Because stops 302 are preferably located nearly or directly below trailing edge 312 of the retaining guide 298, the structure to be connected preferably only requires approximately a quarter turn to transition from an unlocked position, in which the lugs of the structure to be connected are located outside leading tabs 300 of retaining guide 298, to a locked position, in which the lugs of the structure to be connected are adjacent stops 302. To disconnect, the structure is rotated a quarter turn in the opposite direction such that the lugs of the structure slide out from under the leading tabs 300.

As discussed above and from the foregoing description of the exemplary embodiments of the invention, it will be readily apparent to those skilled in the art to which the invention pertains that the principles and particularly the structures disclosed herein and the methods of use thereof can be used for applications other than those specifically mentioned. All such applications of the invention are intended to be covered by the appended claims unless expressly excluded therefrom.

The invention may be embodied in other specific forms without departing from the spirit or essential characteristics of the invention. The disclosed embodiments are therefore to be considered in all respects as illustrative and not restrictive with the scope of the invention being indicated by the appended claims rather than by the foregoing description. All changes which come within the meaning and range of equivalency of the claims are therefore intended to be embraced therein.

As used in the claims herein, the term “comprising” means “including” while the term “consisting of” means “including so much and no more” and the term “consisting essentially of” means including the recited elements and those minor accessories required and known to be used in the art to facilitate the invention as claimed. The scope of the invention is, therefore, indicated by the appended claims rather than by the foregoing description and all changes which come within the median range of equivalency of the claims are to be considered to be embraced within the scope of the claims.

1. A multi-plate, quick disconnect assembly comprising:
a. a first plate having at least one arcuate passageway formed therethrough;
b. a second plate having at least one arcuate passageway formed therethrough; and
c. a third plate having at least one arcuate passageway formed therethrough;
wherein the first, second, and third plates are disposed adjacent one another such that the second plate is sandwiched between the first plate and the third plate, and further wherein the third plate comprises a pair of arcuate retaining guides formed adjacent to the at least one arcuate passageway of the third plate, and the second plate comprises a pair of stops formed adjacent to the at least one arcuate passageway of the second plate.

2. The assembly of claim 1, wherein the at least one arcuate passageway of each of the first plate, the second plate, and the third plate are axially aligned with one another.

3. The assembly of claim 1, wherein the arcuate retaining guides of the third plate extend partially into, and on opposite sides of, the at least one arcuate passageway of the third plate so as to form a region of reduced diameter therein.

4. The assembly of claim 1, wherein the arcuate retaining guides of the third plate each have an arc length between 30° and 150°.

5. The assembly of claim 4, wherein the arcuate retaining guides of the third plate have an arc length of 80°.

6. The assembly of claim 1, wherein each arcuate retaining guide comprises a sloped leading tab to a trailing edge.

7. The assembly of claim 6, wherein the sloped leading tab is angled upwardly with respect to a planar surface of the third plate.

8. The assembly of claim 7, wherein the sloped leading tab is angled upwardly at 10°.

9. The assembly of claim 6, wherein the pair of stops on the second plate are rectangular and extend inwardly with respect to the at least one arcuate passageway of the second plate.

10. The assembly of claim 9, wherein the pair of stops are each axially and angularly aligned with respective trailing edges of the pair of arcuate retaining guides of the third plate.

11. The assembly of claim 1, wherein each of the first plate, the second plate, and the third plate comprises two arcuate passageways extending therethrough.

12. The assembly of claim 11, wherein a first arcuate passageway formed through each of the first plate, the second plate, and the third plate is larger in diameter than a second arcuate passageway formed through each of the first plate, the second plate, and the third plate.

13. The assembly of claim 1, wherein the diameter of at least one arcuate passageway formed through the first plate is smaller than the diameter of both the at least one arcuate passageway formed through the second plate and the at least one arcuate passageway formed through the third plate.

14. The assembly of claim 1, wherein the diameters of the at least one arcuate passageway formed through the second plate and the at least one arcuate passageway formed through the third plate are equal.

15. The assembly of claim 1, further comprising a plurality of aligned openings formed through each of the first plate, the second plate, and the third plate for mounting of the assembly to one of a structure, a container, a mechanism, or a conduit.

16. A quick disconnect outlet fitting for controlled delivery of liquid color therethrough from a supply, comprising:
a. a base plate having a pair of arcuate passageways formed therethrough;
b. a spacer plate having a pair of arcuate passageways formed therethrough; and
c. a retainer plate having a pair of arcuate passageways formed therethrough,
wherein the respective arcuate passageways of the base plate, the spacer plate, and the retainer plate are axially aligned, and wherein the spacer plate is disposed between the base plate and the retainer plate such that a bottom surface of the spacer plate is in contact with a top surface of the base plate and a top surface of the spacer plate is in contact with a bottom surface of the retainer plate, and further wherein the retainer plate comprises a pair of retaining guides formed adjacent to the pair of arcuate passageways of the retaining plate, the pair of retaining guides configured to receive respective lugs of a structure to be connected to the fitting.

17. The quick disconnect outlet fitting of claim 16, wherein each of the retaining guides is arcuate and extends from a sloped leading tab to a trailing edge.

18. The quick disconnect outlet fitting of claim 17, wherein the sloped leading tab is angled upwardly.

19. The quick disconnect outlet fitting of claim 17, wherein the spacer plate further comprises a pair of stops extending from an inner periphery of each arcuate passageway of the spacer plate.

20. The quick disconnect outlet fitting of claim 19, wherein each stop is axially and angularly aligned with the trailing edge of the retaining guide disposed thereabove.
